(19) United States
(12) Patent Application Publication
(10) Pub. No.: US 2024/0281539 A1
(43) Pub. Date: Aug. 22, 2024

(54) SYSTEM AND METHOD FOR DETECTING VULNERABILITIES IN OBJECT-ORIENTED PROGRAM CODE USING AN OBJECT PROPERTY GRAPH

(71) Applicant: The Johns Hopkins University, Baltimore, MD (US)

(72) Inventors: Yinzhi Cao, Baltimore, MD (US); Mingqing Kang, Baltimore, MD (US); Song Li, Baltimore, MD (US); Jianwei Hou, Baltimore, MD (US)

(21) Appl. No.: 18/566,938

(22) PCT Filed: Jun. 2, 2022
(86) PCT No.: PCT/US2022/032023

§ 371 Date: Dec. 4, 2023

Related U.S. Application Data
(60) Provisional application No. 63/195,991, filed on Jun. 2, 2021.

(51) Int. Cl. G06F 21/57

(52) U.S. Cl. CPC G06F 21/577; G06F 2221/033

(57) ABSTRACT

Methods, systems, and computer programs for generating a data structure that represents features of object-oriented program code. In one aspect, the method includes actions of obtaining object-oriented program code, generating an abstract syntax tree based on the obtained object-orient program code, generating one or more graph nodes based on the semantics of the abstract syntax tree nodes, wherein each generated graph node corresponds to an object of the object-oriented program code, and generating one or more graph edges, wherein each generated graph edge: begins at a node of the abstract syntax tree and terminates at one of the generated graph nodes, and represents a use, by the object-oriented program code, of an object represented by the generated graph node where the generated graph edge terminates.

### CROSS-REFERENCE TO RELATED APPLICATIONS

This application claims the benefit of U.S. provisional application No. 63/195,991, filed Jun. 2, 2021, which is herein incorporated by reference in its entirety.

### FEDERALLY SPONSORED RESEARCH OR DEVELOPMENT

This invention was made with government support under FA8750-19-C-0006 awarded by the Air Force Research Laboratory. The government has certain rights in the invention.

### BACKGROUND

Object-oriented programming (OOP) is a computer programming model that organizes software design around data, or objects, rather than functions and logic.

### SUMMARY

According to one innovative aspect of the present disclosure, a method for generating a data structure that represents features of object-oriented program code is disclosed. In one aspect, the method can include actions of obtaining, by one or more computers, object-oriented program code, generating, by one or more computers, an abstract syntax tree based on the obtained object-orient program code, generating, by one or more computers, one or more graph nodes based on the semantics of the abstract syntax tree nodes, wherein each generated graph node corresponds to an object of the object-oriented program code, and generating, by one or more computers, one or more graph edges, wherein each generated graph edge: begins at a node of the abstract syntax tree and terminates at one of the generated graph nodes, and represents a use, by the object-oriented program code, of an object represented by the generated graph node where the generated graph edge terminates.

Other aspects includes apparatuses, systems, and computer programs for performing the actions of the aforementioned operations.

The innovative method can include other optional features. For example, in some implementations, data representing use of the object represented by the generated graph node where the generated graph edge terminations can include (i) data representing one or more properties of the object represented by the generated graph node or (ii) data representing one or more data dependencies between the generated graph node and one or more other generated graph nodes.

In some implementations, data representing one or more data dependencies can include data representing a control-flow dependency.

In some implementations, the method can further include deleting, by one or more computers, one or more of the generated graph nodes or one or more of the graph edges.

In some implementations, the method can further include adding, by one or more computers, one or more of additional generated graph edges or one or more additional graph edges.

In some implementations, the method can further include updating, by one or more computers, one or more of the generated graph nodes or graph edges.

In some implementations, the method can further include using, by one or more computers, the generated data structure to detect one or more vulnerabilities of the object-oriented program code.

In some implementations, using, by one or more computers, the generated data structure to detect one or more vulnerabilities of the object-oriented program code can include generating, by one or more computers, a query that is configured to search the generated data structure for a template pattern of generated graph nodes and graph edges, and executing, by one or more computers, the generated query against the generated data structure.

In some implementations, the one or more graph nodes and the one or more graph edges are generated using two-phase abstract interpretation.

According to another innovative aspect of the present disclosure, a method for detecting vulnerabilities in object-oriented program code is disclosed. In one aspect, the method can include actions of generating, by one or more computers, a query that is configured to search a data structure representing the object-oriented program code for a template pattern of generated graph nodes and graph edges, wherein the data structure includes an abstract syntax tree that was generated based on the semantics of the object-oriented program code, one or more graph nodes that each corresponds to an object of the object-oriented program code, and one or more graph edges that each (i) begin at a node of the abstract syntax tree and terminates at one of the one or more graph nodes, and (ii) represent a use, by the object-oriented program code, of an object represented by the graph node where the generated graph edge terminate, executing, by one or more computers, the generated query against the generated data structure, and determining, by one or more computers and based on results of the executed query, whether one or more vulnerabilities exist in the object-oriented program code.

Other aspects includes apparatuses, systems, and computer programs for performing the actions of the aforementioned operations.

The innovative method can include other optional features. For example, in some implementations, the query is configured to search the data structure for a template pattern that indicates (i) a vulnerable assignment statement controllable by an adversary and (ii) an object property lookup after the vulnerable assignment statement.

In some implementations, the query is configured to search the data structure for a template pattern that indicates an alteration of a built-in function following a prototype chain.

In some implementations, the query is configured to search the data structure for an alteration of a built-in function of the object-orient code that occurs after a node indicating an occurrence of a prototype chain.

In some implementations, the node indicating an occurrence of a prototype chain is a prototype node.

In some implementations, the node indicating an occurrence of a prototype chain is a constructor node.

In some implementations, the constructor node is obj.constructor.prototype.

In some implementations, the query is configured to search the data structure for two or more vulnerable assignment statements controllable by an adversary. In such implementations, the method further can further include based on a determination that execution of the query detected two or more vulnerable assignment statements, correlating, by one or more computers, the vulnerable assignment statements based on object definitions and object use.

In some implementations, the query is configured to search the data structure for a backward taint-flow from a sink to an adversary-controlled program.

These and other innovative aspects of the present disclosure are described in more detail herein in the detailed description, the accompanying drawings, and the claims.

### BRIEF DESCRIPTION OF THE DRAWINGS

FIG. 1 is a block diagram of an example of a system for detecting vulnerabilities in object-oriented program code using an object property graph.

FIG. 2 is a flowchart of an example of a process for generating an object property graph for use in detecting vulnerabilities in object-oriented program code.

FIG. 3 is a flowchart of an example of a process for detecting vulnerabilities in object-oriented program code using an object property graph.

FIG. 4 is a block diagram of system components that can be used to implement a system for detecting vulnerabilities in object-oriented program code using an object property graph.

### DETAILED DESCRIPTION

The present disclosure is directed towards systems, methods, and computer programs generating a novel object property graph that is used for detecting vulnerabilities in object-oriented program code. The object property graph (OPG) is a data structure that comprises a linkage between an abstract syntax tree (AST) that represents the object-oriented program code (OOPC) and an additional graph structure having one or more additional graph nodes that each correspond to an object of the OOPC and one or more graph edges that each begin at a node of the AST and terminate at one of the generated additional graph nodes. In the OPG data structure, each edge linking a node of the AST structure to a generated additional nodes represents a use, by the OOPC, of an object represented by the generated graph node where the generated graph edge terminates.

The present disclosure solves problems in the art related to detection of certain vulnerabilities in object-oriented code such as prototype pollution vulnerabilities. In particular, the OPG data structure, once generated, enables a query to be executed against the OPG data structure to search for the occurrence of template patterns within the OPG data structure that are indicative of particular vulnerabilities such as prototype pollution vulnerabilities. Such techniques improve upon conventional methods for detecting prototype pollution vulnerabilities as such conventional methods that adopt fuzz package inputs, which inevitably lead to code coverage issues in triggering some deeply embedded vulnerabilities. In addition, the present disclosure overcomes challenges in the art that exist when trying to use static analysis to detect prototype pollution because of the involvement of prototype chains and fine-grained object relations. Accordingly, the present disclosure provides a vulnerability detection process that improves upon conventional methods by providing accurate and reliable detection of vulnerabilities such as prototype pollution vulnerabilities in a manner that is scalable.

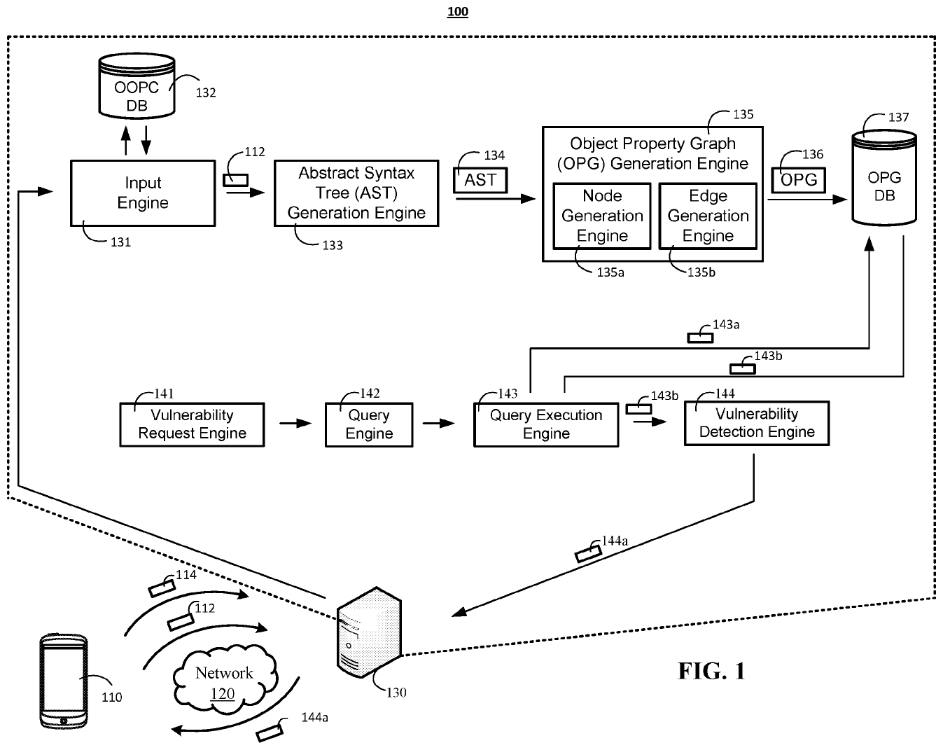

FIG. 1 is a block diagram of an example of a system 100 for detecting vulnerabilities in object-oriented program code using an object property graph. They system 100 can include a user device 110, a network 120, and an application server 130.

The user device 110 can include any device that is capable of transmitting OOPC 112 or a vulnerability request 114 to the application server 130 via the network 120. Such a user device 110 can include a smartphone, a tablet computer, a laptop computer, a desktop computer, or the like. The network 120 can include one or more wired or wireless networks configured to facilitate communications between the user device 110 and the application server 130. In some implementations, the network 120 can include, for example, a wired Ethernet networks, a wireless WIFI network, a LAN, a WAN, a cellular network, the Internet, or any combination thereof.

The application server 130 can include one or more computers capable communicating with the user device 110 via the network 120 and hosting one or more processing engines. In particular, the application server 130 includes an input engine 131, an OOPC database 132, an abstract syntax tree (AST) generation engine 133, an object property graph (OPG) generation engine 135, an object property graph (OPG) database 16, a vulnerability request engine 141, a query engine 142, a query execution engine 143, and a vulnerabilities detection engine 144. Though each of the aforementioned engines and database are depicted and described as being included in the application server 130, the present disclosure is not so limited. Instead, in some implementations, one or more of the engines or databases can be hosted on the user device 110 or any other computing device. Indeed, in some implementations, all of aforementioned engines, all of the aforementioned databases, or any subset thereof, may be hosted on a user device 110 so that all, or a portion, of the functionality described herein can be executed on a user device 110. Finally, and for purposes of this specification, an “engine” comprises software instructions, hardware components, or any combination thereof that are configured to realize the functionality attributed to the engine by this specification.

Execution of the system begins with the input engine 131 obtaining OOPC 112. The input engine 131 can obtain the OOPC 112 in a number of different ways. For example, in some implementations, the input engine 131 can obtain OOPC 112 that was provided by the user device 110 via the network 130 to the application server 130. In such implementation, for example, a user of the user device 110 may have OOPC 112 that the user would like to test for vulnerabilities such as prototype pollution vulnerabilities. Alternatively, in other implementations, the input engine 31 can obtain OOPC 112 from an object-oriented code database 132. The input engine 31 can provide the obtained OOPC 112 as an input to the AST generation engine 133.

The AST generation engine 133 is configured to process the OOPC 112 to generate an AST 134. Processing the OOPC 112 to generate the AST 134 comprises parsing the OOPC 112 into respective programmatic constructs to be included in the AST. Once parsed, the AST generation engine 133 assembles the parsed constructs into an AST, with each node of the AST representing a particular construct occurring in the OOPC and the AST, as a whole, representing the abstract syntactic structure of the OOPC. The generated AST 134 is a tree-like structure that represents syntactic constructs of the OOPC 112 such as, e.g., while statements, if-then statements, and the like are represented in the AST 134 within a respective node and branches. The generated AST 134 is provided as an input to the OPG generation engine 135.

The OPG generation engine 135 is configured to receive the AST 134, generate nodes of an OPG 135c, and generate edges that link nodes of the AST 134 to one or more nodes of the OPG 135c. The OPG generation engine 135 achieves this functionality using an object node generation engine 135a and an edge generation engine 135b. The data structure that results from linking the AST 134 with one or more object nodes generated by the OPG generation engine using one or more graph edges generated by the OPG generation engine is the OPG data structure 135c.

The OPG data structure 135c integrates the syntactic definition of the operations of the OOPC 112 with each object called on and/or executed by the OOPC 112. Thus, the OPG data structure 135c can be analyzed to learn attributes of the OOPC 112. For example, in some implementations, a first template pattern of object nodes and graph edges may be defined as corresponding to a vulnerability such as prototype pollution. Then, once generated, the OPG data structure 135c can be queried to determine whether, e.g., the first template pattern of nodes, edges, or both, occur in the OPG data structure 135c. If it is determined that the first template pattern of nodes, edges, or both, occur in the OPG data structure 135c, then the system 100 can determine that the vulnerability corresponding to the first template pattern of nodes, edges, or both exists in the OOPG 112 from which the OPG was generated.

In more detail, the object node generation engine 135a processes the AST 134 and generates one or more objet graph nodes based on the semantics of the AST 134 nodes. For example, in some implementations, the object node generation engine 135a can process the AST to identify each object of the OOPG 112 and then generate an object graph node for each identified object. In some implementations, one object graph node is generated for each object of the OOPC 112, with each generated object graph node corresponding to one particular object of the OOPC 112. An object can include, for example, an abstract data type created by a developer of the OOPC 112.

The edge generation engine 135b generates one or more graph edges that begin at a node of the AST 134 and terminate at one of the generated graph nodes. Each generated graph edge represents a use OOPC 112 of an object represented by the generated graph node where the generated graph edge terminates. In some implementations, data representing use of the object represented by the generated graph node where the generated graph edge terminations can include (i) data representing one or more properties of the object represented by the generated graph node, (ii) data representing one or more data dependencies between the generated graph node and one or more other generated graph nodes, or both. In some implementations, the data representing one or more data dependencies includes data representing a control-flow dependency.

In some implementations, the OPG generation engine 135 can generate the OPG 136 using a two-phase approach abstract interpretation approach. The two-phase abstract interpretation approach includes a bottom-up approach and a top-down approach.

In the first phase of the two-phase approach, which can be referred to as bottom-up abstract interpretation, the OPG generation engine 135 can construct a control-flow and call graph that includes asynchronous call edges and an intra procedural data-flow graph. In such implementations, the OPG generation engine 135 can follow function scopes instead of call sequences for abstract interpretation. This enables a key technical improvement of more efficient analysis of an OOPC 112 function from the beginning to the end only once, rather than repeating the analysis once per function call. In addition, the complexity of OOPC 112 function call resolution is captured by constructing OPG 136 that describes how functions create, resolve, or trigger the execution of other functions. The constructed OPG 136 can accurately and efficiently resolve function calls until all the needed information (e.g., function pointers) is available and annotated.

In the second phase of the two-phase approach, which can be referred to as a top-down abstract interpretation, the OPG generation engine 135 can construct an inter procedural data-flow graph following specific control-flow and data-flow paths. In such implementations, the OPG graph generation engine 135 only analyzes a subset of statements that are related to the next function in the control-flow graph, called an intermediate sink, along the control-flow path. That is, the top-down abstract interpretation approach prunes the program and only analyzes statements with control and data dependencies on the possible taint-style sink, making it scalable compared with traditional abstract interpretation.

The OPG generation engine 135 can store the generated OPG 136 in one or more memory devices. For example, in some implementations, the OPG generation engine 135 can store the generated OPG 135 in an OPG database 137. The OPG database 137 can be local to the application server 130 or located remotely from the application server 130. If located remotely by from the application server 130, the application server 130 can be configured to communicate with the OPG database 137 using one or more networks 120. In some implementations, upon storage of the generated OPG 136 in the OPG DB 137, the application server 130 can send a confirmation notification 113 to the user device 110 indicating that the OPG 136 has been generated and stored.

In some implementations, the OPG generation engine 135 can also be configured to update a generated OPG 136 that is stored in the OPG database 137. For example, the OPG generation engine 135 can be configured to detect changes in OOPC associated with a generated OPG 136 stored in the OPG DB 137 and then add one or more object graph nodes, delete one or more object graph nodes, or both, based on the respective additions of objects, deletion of object, or both, detected in the OOPC. In some implementations, detecting changes in OOPC associated with the OPG 136 can include receiving an instruction from a user indicating that the OOPC has changed. In other implementations, the OPG generation engine 135 can monitor a program code repository such as program code database 132 and detect changes to OOPC associated with a generated OPG 136 without user interaction.

By way of another example, the OPG generation engine 135 can be configured to detect changes in OOPC associated with a generated OPG 136 stored in the OPG DB 137 and then add one or more graph edges, delete one or more graph edges, or both, based on the respective changes in use of objects by the constructs of the OOPC detected by the OPG generation engine 135. In yet another example, in some implementations, updating may include changing one or more attributes or dependencies associated with a graph edge without adding or deleting a graph edge.

The system 100 can be used to detect vulnerabilities in the OOPC 112. Detecting vulnerabilities of OOPC 112 can begin with a user submitting a vulnerability request 114 using the user device 110. The vulnerability request 114 can include data that identifies OOPC 112 and data indicating that a vulnerability evaluation of OOPC 112 is to be performed. In some implementations, the vulnerability request can identify OOPC 112 for which an OPG 136 has already been generated and stored in the OPB data 137. In other implementations, the vulnerability request 114 can include a copy of the OOPC 112 that is to be subjected to a vulnerability evaluation. In such instances, the system 100 will first process the OOPC 112 through the input engine 131, the AST generation engine 133, the OPG generation engine 135, and store the generated OPG 136 in the OPG DB 137 before performing the vulnerability evaluation.

The vulnerability request engine 141 is configured to receive a vulnerability request 114 and initiate a vulnerability evaluation of the OOPC 112 identified by, or otherwise associated with, the vulnerability request 114. However, the present disclosure is not so limited. Instead, in some implementations, the vulnerability request engine 141 can be configured to initiate, without user interaction, a vulnerability evaluation of OOPC stored, e.g., in program code database 132 or having a OPG graph 136 stored in the OPG DB 137.

Once an OPG graph 136 is generated and stored in OPG DB 137 for OOPC 112, the vulnerability request engine 141 can initiate a vulnerability evaluation by instructing the query engine 142 to generate a query for searching the OPG graph 136. The query is configured to search an OPG graph 136 data structure representing the OOPC for a template pattern of generated graph nodes and graph edges indicative of a vulnerability. In some implementations, for example, a query can be configured go search the OPG graph 136 for vulnerabilities that including an internal property tampering vulnerability, a prototype pollution vulnerability, an injection vulnerability, or an improper file access vulnerability. Other types of vulnerabilities may also be discovered using techniques of the present disclosure by configuring the query to identify the template of OPG graph nodes and edges indicative of the vulnerability.

An existing OPG graph 136 can be searched for an indication of one or multiple vulnerabilities in the OOPC 112. If only a single vulnerability is to be searched, that a single query configured to search for the single vulnerability is generated. Alternatively, to the extent that an OPG graph 136 is to be searched for multiple different vulnerabilities, then a query for each vulnerability to be searched is generated, and respectively configured, to search for a particular vulnerability, each query searching for an indication of a single vulnerability.

In some implementations, the vulnerability request 114 can indicate whether one vulnerability, multiple vulnerabilities, or all known vulnerabilities are searched for during a vulnerability evaluation of an OOPC 112 using an OPG graph 136. In other implementations, the vulnerability request engine 141 may automatically and dynamically make the determination as to whether one vulnerability, multiple vulnerabilities, or all vulnerabilities are to be searched.

An example of vulnerability that can be evaluated using the techniques of the present disclosure is an internal property tampering vulnerability. An internal property tampering (IPT) vulnerability allows an adversary to alter an internal property either under an object directly or a prototypical object, so that future property lookups is affected. An IPT has two main conditions: (i) a vulnerable assignment statement controllable by an adversary, and (ii) a property lookup after the vulnerable assignment statement controllable by an adversary. Graph traversals to identify the vulnerability may be prototypical or direct. Accordingly, in some implementations, a query is configured to search an OPG graph 136 to detect an occurrence of an IPT vulnerability by configuring the query to search for (i) a vulnerable assignment statement controllable by an adversary and (ii) an object property lookup after the vulnerable assignment statement. For purposes of the present disclosure, an adversary can include an entity attempting to exploit the vulnerability.

Another example of a vulnerability that can be evaluated using techniques of the present disclosure is a prototype pollution vulnerability. A prototype pollution vulnerability is allows an adversary to alter a built-in function following the prototype chain. There are traditionally two prototype pollution patterns: (i) one is through prototype node such as, e.g., _proto_ (i.e., obj.proto_toString) and (ii) the other through constructor, e.g., obj.constructor.prototype. The former has two vulnerable assignments before the target and the latter has three.

Accordingly, a query can be configured in multiple ways to search an OPG graph structure 136 for a prototype pollution pattern. In some implementations, for example, a query is configured to search an OPG Graph structure 136 for a prototype pollution vulnerability by searching for a template pattern that indicates an alteration of a built-in function following a prototype chain. Alternatively, or in addition, the query is configured to search the OPG graph data structure 136 for an alteration of a built-in function of the OOPC that occurs after a node indicating an occurrence of a prototype chain. In such implementations, the query is configured to search the OPG graph structure 136 for a node indicating an occurrence of a prototype chain by being configured to search for a prototype node. Alternatively, in such implementations, the query is configured to search the OPG graph structure 136 for a node indicating an occurrence of a prototype chain by being configured to search for a constructor node. In some implementations, for example, the constructor node that the query is configured to search for is an obj.constructor.prototype.

Another example of a vulnerability that can be evaluated using techniques of the present disclosure is an injection vulnerabilities. An injection vulnerability allows an adversary to execute arbitrary code via injections into a sink function via user inputs. Such vulnerabilities are detected via finding a backward taint-flow from a sink to an adversary-controlled source and we model this taint-flow as UNSANITIZED_ARG_sink. Accordingly, a query is configured to search the OPG data structure 136 for a backward taint-flow from a sink to an adversary-controlled source.

Another example of a vulnerability that can be evaluated using techniques of the present disclosure is an improper file access vulnerability. An improper file access vulnerability allows an adversary to either read or write files on the file system without a proper permission. A first example of an improper file access vulnerability is a path traversal

vulnerability. A path or directory traversal allows an adversary to navigate through directories via../ to access local files. Such a vulnerability is detected by configuring a query to search the OPG data structure 136 collect data related to web server creation, to the callback of HTTP(s) request, then to a file read (ReadFile), and finally to the HTTP(s) response.

Another example of an improper file access vulnerability is a path traversal vulnerability is an arbitrary file write vulnerability. An arbitrary file read allows an adversary to write to arbitrary files due to improper input validation. Such a vulnerability is detected by configuring a query to search the OPG data structure 136 for a vulnerability from a web server creation to the callback.

The query execution engine 143 is configured to execute the one or more generated queries 143a against the OPG data structure 136 stored in the OPG database 137. The query execution engine 143 can obtain results 143b to the query 143a and provide the obtained results to the vulnerabilities detection engine 144.

The vulnerabilities detection engine 144 is configured to determine, based on results 143b of the executed query 143a, whether one or more vulnerabilities exist in the object-oriented program code. Determining, by the vulnerabilities engine 144, whether one or more vulnerabilities exist can include, for example, determining whether the search results 143b for each of the executed queries 143a indicates that the OPG graph template that was searched for with the query 143a was identified by execution of the query 143a. If it is determined, by the vulnerability detection engine 144 that the query results 143b indicate that a searched for template was identified in the OPG 136, then the vulnerability detection engine 144 can determine that a vulnerability corresponding to the query 143a exists.

By way of example, assume the query 143a is configured to search the OPG 136 graph structure for a prototype pollution vulnerability. In such an implementations, the query 143a is configured to search the OPG Graph structure 136 for a prototype pollution vulnerability template by searching for a template pattern that indicates an alteration of a built-in function following a prototype chain. After execution of the query 143a configured to search for a prototype pollution vulnerability template is executed by the query execution engine 143, the search results 143b for the executed query 143a are provided to the vulnerability detection engine 144. Then, the vulnerability detection engine 144 can determine whether the search results indicate that a prototype pollution vulnerability template was detected by the query 143a and indicated in the search results 143b.

For example, the vulnerability detection engine 143 can determine whether the execute query 143a caused search results 143b to be returned indicating that alteration of a built-in function following a prototype chain was detected. If the search results 143b indicate that an alteration of a built-in function following a prototype chain was detected, then the vulnerability detection engine 144 can determine that there is a prototype pollution vulnerability in the OOPC 112 that the OPG 136 represents. Alternatively, if the search results 143b indicate that an alteration of a built-in function following a prototype chain was not detected, then the vulnerability detection engine 144 can determine that there is not a prototype pollution vulnerability in the OOPC 112 that the OPG 136 represents. Though this examples is explicitly set forth for a prototype pollution vulnerability, the vulnerability detection engine 143 functions in the same general manner for each of the other vulnerabilities.

The vulnerability detection engine 143 can output data 144a indicating whether or not one or more vulnerabilities were detected based on an evaluation of the search results 143b. In some implementations, the application server 130 can transmit the output data 144a to the user device 110 using the network 120. In some implementations, the user device 110 can process render one or more displays in the graphical user interface of the user device 110 that provide one or more visualizations indicating whether or not one or more vulnerabilities of the OOPC 112 were detected.

As noted above, there is not required that only one vulnerability can be searched for by a single query 143a. For example, in some implementations, the query execution engine 143 may search the OPG data structure 136 for two or more vulnerable assignment statements controllable by an adversary. In such implementations, the vulnerabilities detection engine 144 can detect, based on the search results 143b, two or more vulnerable assignment statements. In such implementations, the vulnerabilities detection engine can correlate the vulnerable assignment statements based on object definitions and object use.

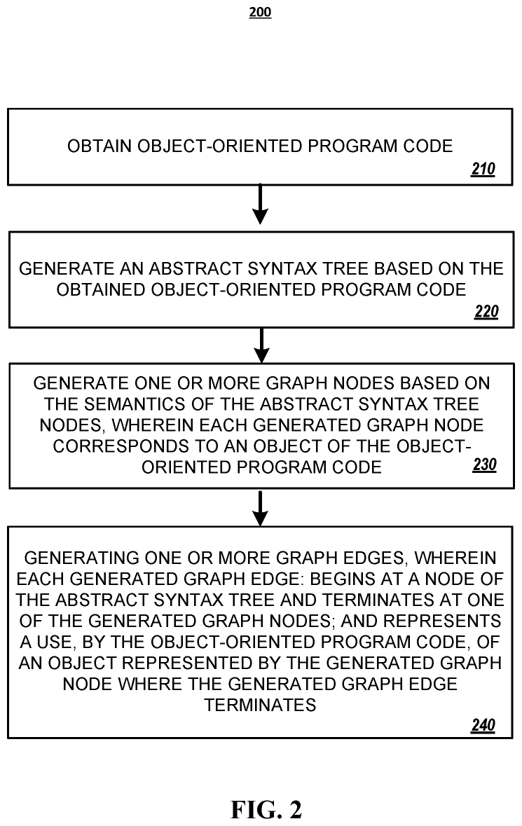

FIG. 2 is a flowchart of an example of a process 200 for generating an object property graph for use in detecting vulnerabilities in object-oriented program code. The process 200 will be described as being performed by a server such as the application server 130 of FIG. 1. Though process 200 is described as being performed by a server, the present disclosure is not so limited. Instead, in some implementations, the process 200 can be fully or partially executed by a user device 110 or any other computing device.

The server can continue execution of the process 200 by generating, using one or more computers, an abstract syntax tree based on the obtained object-orient program code (220).

The server can continue execution of the process 200 by generating, using one or more computers, one or more graph nodes based on the semantics of the abstract syntax tree nodes, wherein each generated graph node corresponds to an object of the object-oriented program code (230).

The server can continue execution of the process 200 by generating, by one or more computers, one or more graph edges (240), wherein each generated graph edge: begins at a node of the abstract syntax tree and terminates at one of the generated graph nodes, and represents a use, by the object-oriented program code, of an object represented by the generated graph node where the generated graph edge terminates.

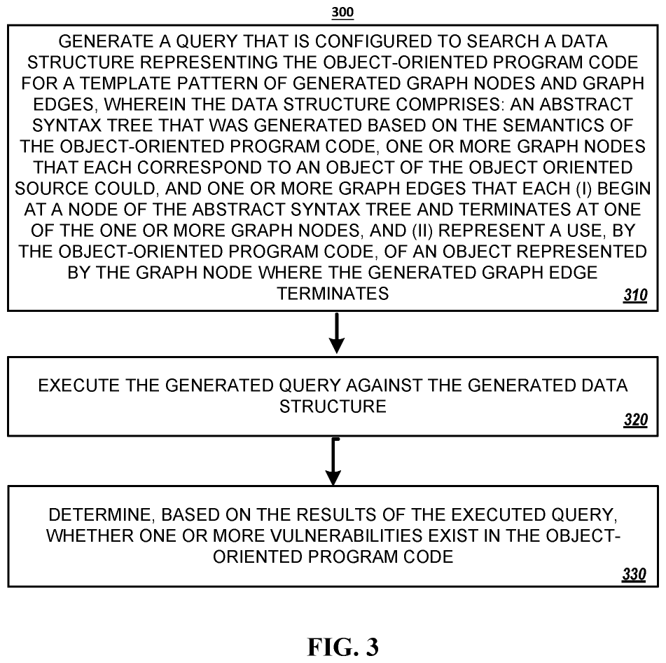

FIG. 3 is a flowchart of an example of a process 300 for detecting vulnerabilities in object-oriented program code using an object property graph. The process 300 will be described as being performed by a server, such as application server 1 of FIG. 3. Though process 300 is described as being performed by a server, the present disclosure is not so limited. Instead, in some implementations, the process 300 can be fully or partially executed by a user device 110 or any other computing device.

A server can begin execution of the process 300 by generating, by one or more computers, a query that is configured to search a data structure representing the object-oriented program code for a template pattern of generated graph nodes and graph edges (310). In such implementations, data structure representing the object-oriented program code comprises: an abstract syntax tree that was generated based on the semantics of the object-oriented program code, one or more graph nodes that each corresponds to an object of the object-oriented program code, and one or more graph edges that each (i) begin at a node of the abstract syntax tree and terminates at one of the one or more graph nodes, and (ii) represent a use, by the object-oriented program code, of an object represented by the graph node where the generated graph edge terminate.

The server can continue execution of the process 300 by using one or more computers to execute the generated query against the generated data structure (320).

The server can continue execution of the process 300 by using one or more computers to determine, based on results of the executed query, whether one or more vulnerabilities exist in the object-oriented program code (330).

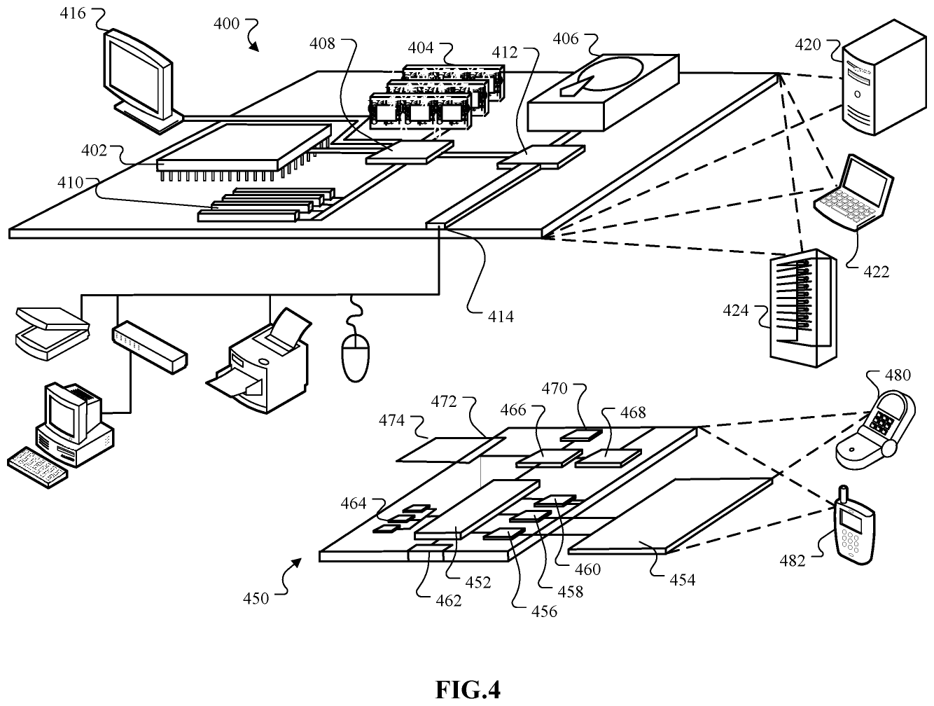

FIG. 4 is a block diagram of system components that can be used to implement a system for detecting vulnerabilities in object-oriented program code using an object property graph.

Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. Additionally, computing device 400 or 450 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be examples only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and can be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations, e.g., as a server bank, a group of blade servers, or a multi-processor system.

The memory 404 stores information within the computing device 400. In one implementation, the memory 404 is a volatile memory unit or units. In another implementation, the memory 404 is a non-volatile memory unit or units. The memory 404 can also be another form of computer-readable medium, such as a magnetic or optical disk.

The storage device 406 is capable of providing mass storage for the computing device 400. In one implementation, the storage device 406 can be or contain a computer-readable medium, such as a floppy disk device, a hard disk device, an optical disk device, or a tape device, a flash memory or other similar solid-state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low speed controller 412 manages lower bandwidth intensive operations. Such allocation of functions is only an example. In one implementation, the high-speed controller 408 is coupled to memory 404, display 416, e.g., through a graphics processor or accelerator, and to high-speed expansion ports 410, which can accept various expansion cards (not shown). In the implementation, low-speed controller 412 is coupled to storage device 406 and low-speed expansion port 414. The low-speed expansion port, which can include various communication ports, e.g., USB, Bluetooth, Ethernet, wireless Ethernet can be coupled to one or more input/output devices, such as a keyboard, a pointing device, microphone/speaker pair, a scanner, or a networking device such as a switch or router, e.g., through a network adapter. The computing device 400 can be implemented in a number of different forms, as shown in the figure. For example, it can be implemented as a standard server 420, or multiple times in a group of such servers. It can also be implemented as part of a rack server system 424. In addition, it can be implemented in a personal computer such as a laptop computer 422. Alternatively, components from computing device 400 can be combined with other components in a mobile device (not shown), such as device 450. Each of such devices can contain one or more of computing device 400, 450, and an entire system can be made up of multiple computing devices 400, 450 communicating with each other.

The computing device 400 can be implemented in a number of different forms, as shown in the figure. For example, it can be implemented as a standard server 420, or multiple times in a group of such servers. It can also be implemented as part of a rack server system 424. In addition, it can be implemented in a personal computer such as a laptop computer 422. Alternatively, components from computing device 400 can be combined with other components in a mobile device (not shown), such as device 450. Each of such devices can contain one or more of computing device 400, 450, and an entire system can be made up of multiple computing devices 400, 450 communicating with each other.

Computing device 450 includes a processor 452, memory 464, and an input/output device such as a display 454, a communication interface 466, and a transceiver 468, among other components. The device 450 can also be provided with a storage device, such as a micro-drive or other device, to provide additional storage. Each of the components 450, 452, 464, 454, 466, and 468, are interconnected using various buses, and several of the components can be mounted on a common motherboard or in other manners as appropriate.

The processor 452 can execute instructions within the computing device 450, including instructions stored in the memory 464. The processor can be implemented as a chipset of chips that include separate and multiple analog and digital processors. Additionally, the processor can be implemented using any of a number of architectures. For example, the processor 410 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 450, such as control of user interfaces, applications run by device 450, and wireless communication by device 450.

Processor 452 can communicate with a user through control interface 458 and display interface 456 coupled to a display 454. The display 454 can be, for example, a TFT (Thin-Film-Transistor Liquid Crystal Display) display or an OLED (Organic Light Emitting Diode) display, or other appropriate display technology. The display interface 456 can comprise appropriate circuitry for driving the display 454 to present graphical and other information to a user. The control interface 458 can receive commands from a user and convert them for submission to the processor 452. In addition, an external interface 462 can be provided in communication with processor 452, so as to enable near area communication of device 450 with other devices. External interface 462 can provide, for example, for wired communication in some implementations, or for wireless communication in other implementations, and multiple interfaces can also be used.

The memory 464 stores information within the computing device 450. The memory 464 can be implemented as one or more of a computer-readable medium or media, a volatile memory unit or units, or a non-volatile memory unit or units. Expansion memory 474 can also be provided and connected to device 450 through expansion interface 472, which can include, for example, a SIMM (Single In Line Memory Module) card interface. Such expansion memory 474 can provide extra storage space for device 450, or can also store applications or other information for device 450. Specifically, expansion memory 474 can include instructions to carry out or supplement the processes described above, and can also include secure information. Thus, for example, expansion memory 474 can be provided as a security module for device 450, and can be programmed with instructions that permit secure use of device 450. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452 that can be received, for example, over transceiver 468 or external interface 462.

Device 450 can communicate wirelessly through communication interface 466, which can include digital signal processing circuitry where necessary. Communication interface 466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, such as using a Bluetooth, Wi-Fi, or other such transceiver (not shown). In addition, GPS (Global Positioning System) receiver module 470 can provide additional navigation- and location-related wireless data to device 450, which can be used as appropriate by applications running on device 450.

Device 450 can also communicate audibly using audio codec 460, which can receive spoken information from a user and convert it to usable digital information. Audio codec 460 can likewise generate audible sound for a user, such as through a speaker, e.g., in a handset of device 450. Such sound can include sound from voice telephone calls, can include recorded sound, e.g., voice messages, music files, etc. and can also include sound generated by applications operating on device 450.

The computing device 450 can be implemented in a number of different forms, as shown in the figure. For example, it can be implemented as a cellular telephone 480. It can also be implemented as part of a smartphone 482, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

### OTHER EMBODIMENTS

A number of embodiments have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1-11. (canceled)

12. A method for detecting vulnerabilities in object-oriented program code, the method comprising:
generating, by one or more computers, a query that is configured to search a data structure representing the object-oriented program code for a template pattern of generated graph nodes and graph edges, wherein the data structure comprises:
an abstract syntax tree that was generated based on the semantics of the object-oriented program code,
one or more graph nodes that each corresponds to an object of the object-oriented program code, and
one or more graph edges that each (i) begin at a node of the abstract syntax tree and terminates at one of the one or more graph nodes, and (ii) represent a use, by the object-oriented program code, of an object represented by the graph node where the generated graph edge terminate;
executing, by one or more computers, the generated query against the generated data structure; and
determining, by one or more computers and based on results of the executed query, whether one or more vulnerabilities exist in the object-oriented program code.

13. The method of claim 12, wherein the query is configured to search the data structure for a template pattern that indicates (i) a vulnerable assignment statement controllable by an adversary and (ii) an object property lookup after the vulnerable assignment statement.

14. The method of claim 12, wherein the query is configured to search the data structure for a template pattern that indicates an alteration of a built-in function following a prototype chain.

15. The method of claim 12, wherein the query is configured to search the data structure for an alteration of a built-in function of the object-orient code that occurs after a node indicating an occurrence of a prototype chain.

16. The method of claim 15, wherein the node indicating an occurrence of a prototype chain is a prototype node.

17. The method of claim 15, wherein the node indicating an occurrence of a prototype chain is a constructor node.

18. The method of claim 17, wherein the constructor node is obj.constructor.prototype.

19. The method of claim 12,
wherein the query is configured to search the data structure for two or more vulnerable assignment statements controllable by an adversary, and
wherein the method further comprises:
based on a determination that execution of the query detected two or more vulnerable assignment statements, correlating, by one or more computers, the vulnerable assignment statements based on object definitions and object use.

20. The method of claim 12, wherein the query is configured to search the data structure for a backward taint-flow from a sink to an adversary-controlled program.

21-22. (canceled)

23. As system for detecting vulnerabilities in object-oriented program code, the method comprising:
one or more computers; and
one or more computer-readable storage devices storing instructions that, when executed by the one or more computers, cause the one or more computers to perform operations comprising:
generating, by the one or more computers, a query that is configured to search a data structure representing the object-oriented program code for a template pattern of generated graph nodes and graph edges, wherein the data structure comprises:
an abstract syntax tree that was generated based on the semantics of the object-oriented program code,
one or more graph nodes that each corresponds to an object of the object-oriented program code, and
one or more graph edges that each (i) begin at a node of the abstract syntax tree and terminates at one of the one or more graph nodes, and (ii) represent a use, by the object-oriented program code, of an object represented by the graph node where the generated graph edge terminate;
executing, by the one or more computers, the generated query against the generated data structure; and
determining, by the one or more computers and based on results of the executed query, whether one or more vulnerabilities exist in the object-oriented program code.

24. The system of claim 23, wherein the query is configured to search the data structure for a template pattern that indicates (i) a vulnerable assignment statement controllable by an adversary and (ii) an object property lookup after the vulnerable assignment statement.

25. The system of claim 23, wherein the query is configured to search the data structure for a template pattern that indicates an alteration of a built-in function following a prototype chain.

26. The system of claim 23, wherein the query is configured to search the data structure for an alteration of a built-in function of the object-orient code that occurs after a node indicating an occurrence of a prototype chain.

27. The system of claim 26, wherein the node indicating an occurrence of a prototype chain is a prototype node.

28. The system of claim 26, wherein the node indicating an occurrence of a prototype chain is a constructor node.

29. The system of claim 28, wherein the constructor node is obj.constructor.prototype.

30. The system of claim 23,
wherein the query is configured to search the data structure for two or more vulnerable assignment statements controllable by an adversary, and
wherein the operations further comprise:
based on a determination that execution of the query detected two or more vulnerable assignment statements, correlating, by the one or more computers, the vulnerable assignment statements based on object definitions and object use.

31. The system of claim 23, wherein the query is configured to search the data structure for a backward taint-flow from a sink to an adversary-controlled program.

32. One or more computer-readable storage media storing instructions that, when executed by one or more computers, cause the one or more computers to perform operations for detecting vulnerabilities in object-oriented program code, the operations comprising:
generating a query that is configured to search a data structure representing the object-oriented program code for a template pattern of generated graph nodes and graph edges, wherein the data structure comprises:
an abstract syntax tree that was generated based on the semantics of the object-oriented program code,
one or more graph nodes that each corresponds to an object of the object-oriented program code, and
one or more graph edges that each (i) begin at a node of the abstract syntax tree and terminates at one of the one or more graph nodes, and (ii) represent a use, by the object-oriented program code, of an object represented by the graph node where the generated graph edge terminate;
executing the generated query against the generated data structure; and
determining, based on results of the executed query, whether one or more vulnerabilities exist in the object-oriented program code.

33. The computer-readable medium of claim 32, wherein the query is configured to search the data structure for two or more vulnerable assignment statements controllable by an adversary, and
wherein the operations further include:
based on a determination that execution of the query detected two or more vulnerable assignment statements, correlating the vulnerable assignment statements based on object definitions and object use.
